(19) United States
(12) Patent Application Publication
(10) Pub. No.: US 2008/0272057 A1
(43) Pub. Date: Nov. 6, 2008

(54) RECYCLING OF WASTE WATER

(76) Inventor: Lorne TONTEGODE, Ajax (CA)

Correspondence Address: BIRCH STEWART KOLASCH & BIRCH, PO BOX 747, FALLS CHURCH, VA, 22040-0747, US

(21) Appl. No.: 12/114,391

(22) Filed: May 2, 2008

(30) Foreign Application Priority Data
May 3, 2007 (CA) 2,587,124

(51) Int. Cl. C02F 1/00; B01D 21/34

(52) U.S. Cl. 210/739; 210/100; 210/136; 210/137; 210/767

(57) ABSTRACT

An upstream conduit extends from a container containing reusable waste water to a junction and a downstream conduit extends from the junction to a destination for the waste water. There is a third conduit through which fresh water, under pressure, flows to the junction. The flow in the third conduit is controlled by a valve which is normally open but shuts when a flow switch in the downstream conduit detects the demand for the waste water at the destination. At that time the demand is satisfied by waste water from the container. However, should there be insufficient waste water in the container to satisfy the demand, a level switch in the container deactivates or overrides the operation of flow switch thereby causing the valve in the third conduit to open When the valve opens, fresh water from the third conduit satisfies the demand.

### FIELD OF THE INVENTION

This invention relates to a method and apparatus for recycling waste water and more particularly to a method and apparatus for recycling reusable waste water with resultant reduction in quantity of fresh water required for a process and, where heated water is required in the process, resultant savings in the cost of heating the water to a temperature required for such process.

### BACKGROUND OF THE INVENTION

Water used in many processes such as the cleaning and sterilization of returned bottles in a bottling plant and in dry cleaning do not come into contact with significant quantities of pollutants in the processes. The temperature of the water after use is higher than it was before use but otherwise is not significantly changed or more toxic. The water is, accordingly, reasonably clean after use and is suitable for reuse. In general, however, it is not reused. Instead, the water is considered to be non-potable, so-called “waste water” and is flushed down the drain.

I have invented a method and apparatus by which such waste water can be reused for such purposes as laundries, steam generation, toilet flushing and irrigation. The waste water is generally not considered to be potable so it cannot be circulated through a municipal water system but it still is useful for many other purposes.

### SUMMARY OF THE INVENTION

Briefly, the method of my invention includes the steps of: (i) providing a source for waste water; (ii) providing a first conduit which extends from the source to a junction; (iii) causing the waste water to flow downstream through the first conduit to the junction; (iv) restricting the direction of the flow to a downstream direction; (v) detecting when the volume of waste water at the source is below a predetermined value and generating a signal; (vi) providing a second conduit which extends from the junction to a destination for the waste water; (vii) providing a third conduit which extends from a source of alternate water downstream to the junction; (viii) detecting the flow of water through the second conduit; (ix) providing valve means for controlling the flow of alternate water through the third conduit; (x) causing the valve means to close upon detection of the flow of water through the second conduit of step (ix); and (xi) preventing the valve means from closing thereby overriding step (x) upon detection of the signal of step (v).

The apparatus of my invention includes a container in which waste water is collected. There is means such as a level switch for detecting when the volume of waste water in the container is below a pre-determined value. A first conduit extends from the container to a junction and gravity or a pump causes the waste water within the conduit to flow downstream toward the junction. There is a check valve for restricting the flow within the first conduit to a downstream direction. A second conduit extends from the junction to a destination for the waste water.

There is a third conduit through which alternative water, under pressure, flows to the junction. A valve is provided for selectively shutting off the flow of water through the third conduit. There is means, such as a flow switch, for detecting the flow of water through the second conduit and for closing the valve and activating the pump. There is also means for overriding the flow switch, upon detection by the level switch that the volume of waste water in the container is below the predetermined value with resulting opening of the valve and de-activation of the pump.

### DESCRIPTION OF THE DRAWINGS

The method and apparatus of the invention is described in detail with reference to the accompanying drawings in which:

FIG. 1 is a schematic representation of the components of the invention; and

FIG. 2 is a simplified schematic representation of the override electrical circuit in conjunction with the circuit which it controls.

Like reference characters refer to like parts in the drawings.

### DESCRIPTION OF PREFERRED EMBODIMENTS OF THE INVENTION

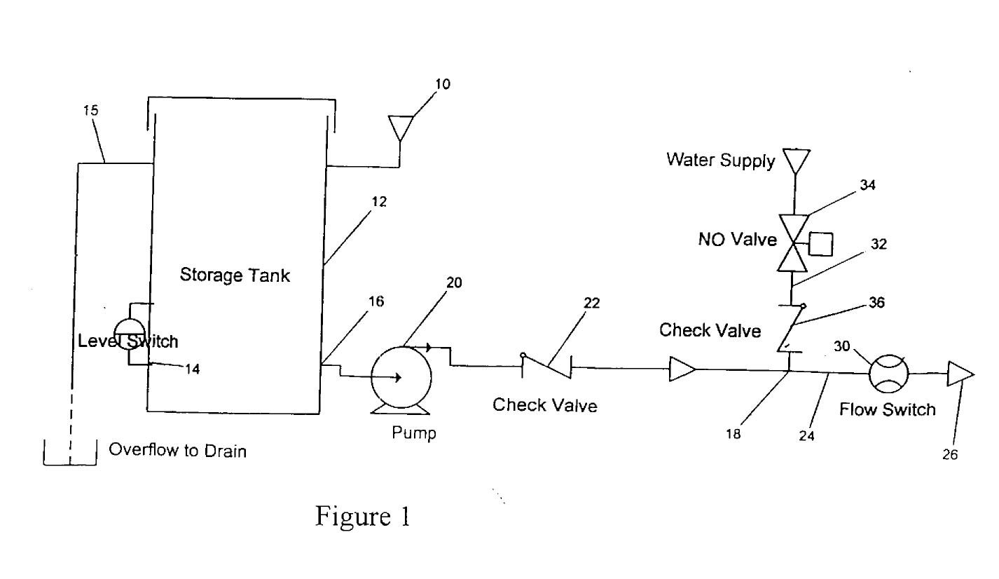

With reference to FIG. 1, numeral 10 indicates a source of waste water to be recycled. The source may be a dry cleaning machine, a bottling plant where hot water is used to sterilize otherwise generally clean bottles and wherever else water is used. Rain water may also be the source of the waste water. The waste water at the source must be sufficiently clean that it is suitable for re-use at the destination of the waste water or must be usable after it is filtered or otherwise treated for removal or neutralization of impurities.

The waste water flows to a tank 12. A level detecting means such as a level switch or ball valve 14 is provided to detect the level of the waste water within the tank. When the level falls below a predetermined value, an electrical signal is generated. On the other hand, when the level exceeds a given level, the excess waste water flows through an overflow conduit 15 to a drain.

A first conduit 16 extends from the lower end of the tank to a junction 18. The junction may be a T-joint which provides an inlet for the waste water and an inlet and outlet for two additional conduits described below.

A pump 20 causes the waste water to flow downstream through the first conduit to the junction and direction limiting means such as a check valve 22 restricts the flow to a downstream direction.

A second conduit 24 extends from the junction to a destination 26 for the waste water. The destination may be a laundry machine, a boiler or wherever else relatively clean but non-potable water is required.

Flow detecting means such as a flow switch 30 detects the flow of waste water through the second conduit. Such flow will occur when there is a demand for the waste water at the destination such as when a laundry machine at the destination is activated.

A third conduit 32 admits alternative water into junction 18. The alternative water is under pressure and maintains the water within the second conduit at the same pressure. The alternative water may originate from a municipal water filtration plant or from a storage tank where there is a reliable supply of water and the water is under pressure by the force of gravity. Shut-off means such as a valve 34 activated by a solenoid which is normally open controls the flow of water through the third conduit.

The operation of the recycling process of my invention is as follows: Waste water at source 10 is directed into storage tank 12 where it is stored until it is needed. Should there be a demand for the waste water at destination 26, water within the second conduit 24 begins to flow toward the destination and that flow will be detected by flow switch 30. Alternative water which is under pressure in the third conduit 32 maintains the water in the second conduit under the same pressure.

When the flow switch detects the flow in the second conduit 24, it activates normally open valve 34 within the third conduit 32 and the valve closes with resulting termination of the flow of alternative water in that conduit. The flow switch also activates pump 20 to accommodate the demand for waste water at the destination.

A second direction limiting means 36 such as a check valve optionally prevents backpressure from affecting the operation of the valve 34 and is useful where the water in the third conduit is not under a constant pressure.

Once pump 20 is activated, waste water flows downstream through the first conduit 16 and junction 18 and joins the water already in the second conduit.

Should the demand for waste water at the destination end, the flow switch deactivates valve 34 to restore the pressure of the alternative water in the third and second conduits. At the same time, flow switch 30 deactivates pump 20 and the recycling process returns to a stand-by mode.

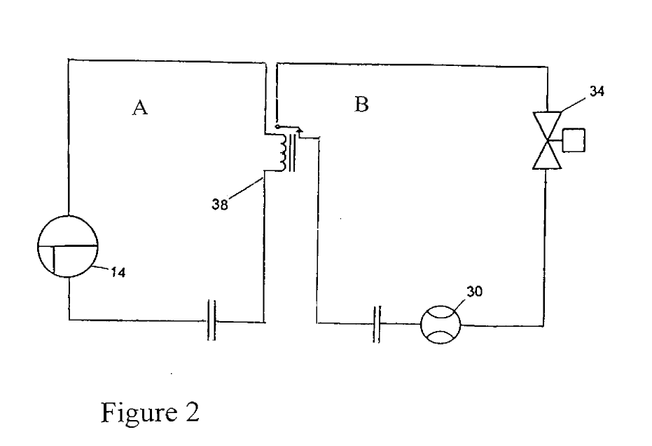

With reference to FIG. 2, should level switch 14 detect that the level of waste water within tank 12 is below a predetermined value, circuit A reacts by deactivating circuit B thereby acting as an override by cancelling the operation of the flow switch. In this regard, switch 14 generates a signal which causes a relay 38 in circuit A to close with resulting opening of Circuit B. Valve 34 then opens to its normal open position thereby allowing alternative water from the third conduit 32 to flow to junction 18 without hindrance

As previously indicated, check valve 22 prevents the alternative water from flowing upstream through the first conduit and ensures that all of the alternative water from the third conduit flows downstream through the second conduit 24 to the destination. There will accordingly be no interruption in the flow of water to the destination should there be insufficient waste water in tank 12.

While it is desirable to employ pump 20 to control the flow of waste water through the first conduit, gravity may be used instead of the pump for the same purpose in which case storage tank 12 must be placed above the first conduit at an appropriate elevation

Should the apparatus malfunction or there be an interruption in electrical power, waste water will continue since the valve is normally open.

It will be understood, of course, that modifications can be made in the method and apparatus of the subject invention without departing from the scope and purview of the invention as defined in the appended claims.

I claim:

1. Apparatus for recycling waste water including: a container in which said waste water is collected; a first conduit extending from said container to a junction; a level detecting means for detecting when the level of waste water in said container is below a predetermined value; direction limiting means for restricting the flow within said first conduit to a direction toward said junction; a second conduit extending from said junction to a destination for said waste water; a third conduit through which alternative water, under pressure, flows to said junction, shut-off means for terminating the flow of alternative water through said third conduit; flow detecting means for detecting the flow of water through said second conduit and for activating said shut-off means with resulting termination of the flow of alternative water in said third conduit; an override for overriding said fourth means upon detection by said first means that the level of waste water in said container is below said predetermined value with resulting opening of the flow of alternative water in said third conduit.

2. The apparatus of claim 1 further including pump means for causing waste water within said first conduit to flow downstream, said flow detecting means causing said pump means to activate upon detection of the flow of water through said second conduit and to deactivate upon detection by said level detecting means that the level of waste water in said container is below a predetermined value.

3. The apparatus of claim 1 further including a second direction limiting means for restricting the flow within said third conduit to a direction toward said junction

4. The apparatus of claim 1 wherein said level detecting means is a level switch and said direction limiting means is a check valve.

5. The apparatus of claim 1 wherein said shut-off means is a valve, said flow detecting means is a flow switch and said override means is a relay.

6. Apparatus for recycling waste water including: a container in which said waste water is collected; a first conduit extending from said container to a junction; a level switch for detecting when the volume of waste water in said container is below a predetermined value; pump means for causing waste water within said first conduit to flow; a check valve for restricting the flow within said first conduit to a direction toward said junction; a second conduit extending from said junction to a destination for said waste water; a third conduit through which alternative water, under pressure, flows to said junction, a valve for shutting off the flow of water through said third conduit; a flow switch for detecting the flow of water through said second conduit and for closing said valve and activating said pump; means for overriding said flow switch upon detection by said level switch that the volume waste water in said container is below said predetermined value with resulting opening of said valve and de-activation of said pump.

7. A method of recycling waste water including the steps of: (i) providing a source for said waste water; (ii) providing a first conduit which extends from said source to a junction; (iii) causing said waste water to flow downstream through said first conduit to said junction; (iv) restricting the direction of said flow to a downstream direction; (v) detecting when the volume of waste water at said source is below a predetermined value and generating a signal; (vi) providing a second conduit which extends from said junction to a destination for said waste water; (vii) providing a third conduit which extends from a source of alternate water downstream to said junction; (viii) detecting the flow of water through said second conduit; (ix) providing valve means for controlling the flow of alternate water through said third conduit; (x) causing said valve means to close upon detection of the flow of water through said second conduit of step (ix); and (xi) preventing said valve means from closing thereby overriding step (x) upon detection of said signal of step (v).

8. The method of claim 7 further including the steps of: (xii) proving pump means for causing said waste water in said first conduit to flow downstream; (xiii) causing said pump to activate upon detection of the flow of water through said second conduit of step (ix); and (xiv) causing said pump to deactivate thereby overriding step (xiii) upon detection of said signal of step (v).

9. The method of claim 8 further including the stop of (xv) restricting the direction of flow of alternative water in said third conduit to a direction toward said junction.
